(19) United States
(12) Patent Application Publication
(10) Pub. No.: US 2012/0041821 A1
(43) Pub. Date: Feb. 16, 2012

(54) Electronic System for Bargaining and Promoting

(76) Inventor: Yang Pan, Singapore (SG)

(21) Appl. No.: 12/856,584

(22) Filed: Aug. 14, 2010

(51) Int. Cl. G06Q 30/00; G06F 15/16

(52) U.S. Cl. 705/14.51; 705/27.1; 705/14.64; 235/375; 709/203

(57) ABSTRACT

An electronic system for bargaining and promoting in a shopping area is disclosed. A mobile communication device carried by a customer may be connected to the electronic system at a point of display item through an ad hoc communication link. The customer may send an offering price for the displayed item. The retailer and the customer may negotiate using the electronic system as long as the mobile device is connected to the system in the shopping area. The customer may also send communication addresses to the system at the point of display item. The retailer may send promotional materials related to the displayed item to the customer through a public communication network.

### CROSS-REFERENCE TO RELATED APPLICATIONS

Not applicable.

### BACKGROUND

1. Field of Invention

This invention relates generally to advertising. More specifically, the invention relates to distributing advertisements through an electronic system.

2. Description of Prior Art

Advertising using traditional media, such as television, radio, newspapers and magazines, is well known. Unfortunately, even when armed with demographic studies and entirely reasonable assumptions about the typical audience of various media outlets, advertisers recognize that much of their advertisement budget is simply wasted. Moreover, it is difficult to identify and eliminate such waste.

Mobile communication devices have gained significant popularity in recent years. Users are using the mobile device such as, for example, iPhone from Apple Inc, Cupertino, Calif., to access the Internet services. Methods for delivering targeted advertisements to users by employing mobile communication devices have been developed. The targeted advertising messages may be delivered based upon the user's personal profile, location and history of the user's interaction with the device. It has always been a significant challenge to understand the user's real interests and to deliver the advertising messages accordingly.

### SUMMARY

It is an object of the present invention to disclose an electronic system to facilitate a purchasing process of a customer in a shopping area.

It is a further object of the present invention to disclose a method that a customer and a retailer negotiate a purchasing agreement for a displayed item through an electronic system.

It is yet another object of the present invention to disclose a method that promotional materials of a displayed item are sent to an interested customer.

In accordance with one embodiment of the present invention, the electronic system comprises a server and a number of client devices. The client devices are connected to the server through a local communication network. Each client device may be associated with a displayed item. A mobile communication device carried by a customer may be connected to one of the client devices through an ad hoc communication link such as, for example, a Bluetooth connection.

In accordance with one aspect of the present invention, the customer may send an offering price for the displayed item from the mobile device to the client device through the ad hoc link. The customer may also send the identity of the mobile device to the client device. The server may send an agreement or a counter offering price to the mobile device through the communication link. The customer may walk around in the shopping area. The mobile device may be connected to the local network through a different client device.

In accordance with another aspect of the present invention, the customer may send an offering price and his communication addresses to the client device associated with a displayed item. The server may send promotional materials related to the displayed item to the customer's communication addresses through a public communication network.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1A is a schematic diagram of an electronic system for facilitating a purchasing process between a customer with a mobile communication device and a retailer operating a local network;

FIG. 1B is a schematic diagram of the electronic system illustrating that the mobile communication device may be connected to the local network through a different client device;

FIG. 2 is a schematic diagram of electronic system illustrating that the mobile communication device may be connected to the server operated by the retailer through a public communication network;

FIG. 3 is a schematic diagram of functional blocks of the electronic system comprising a client device and a mobile communication device;

FIG. 4 is a flowchart illustrating an exemplary process that a customer and a retailer negotiate a purchase agreement by using the electronic system;

FIG. 5 is a flowchart illustrating an exemplary process that promotional materials related to a displayed item are sent to an interested customer through a public communication network;

FIG. 6 is a flowchart illustrating another exemplary process that a customer and a retailer negotiate a purchase agreement by using the electronic system with additional information provided by a data manager connected through a public communication network.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

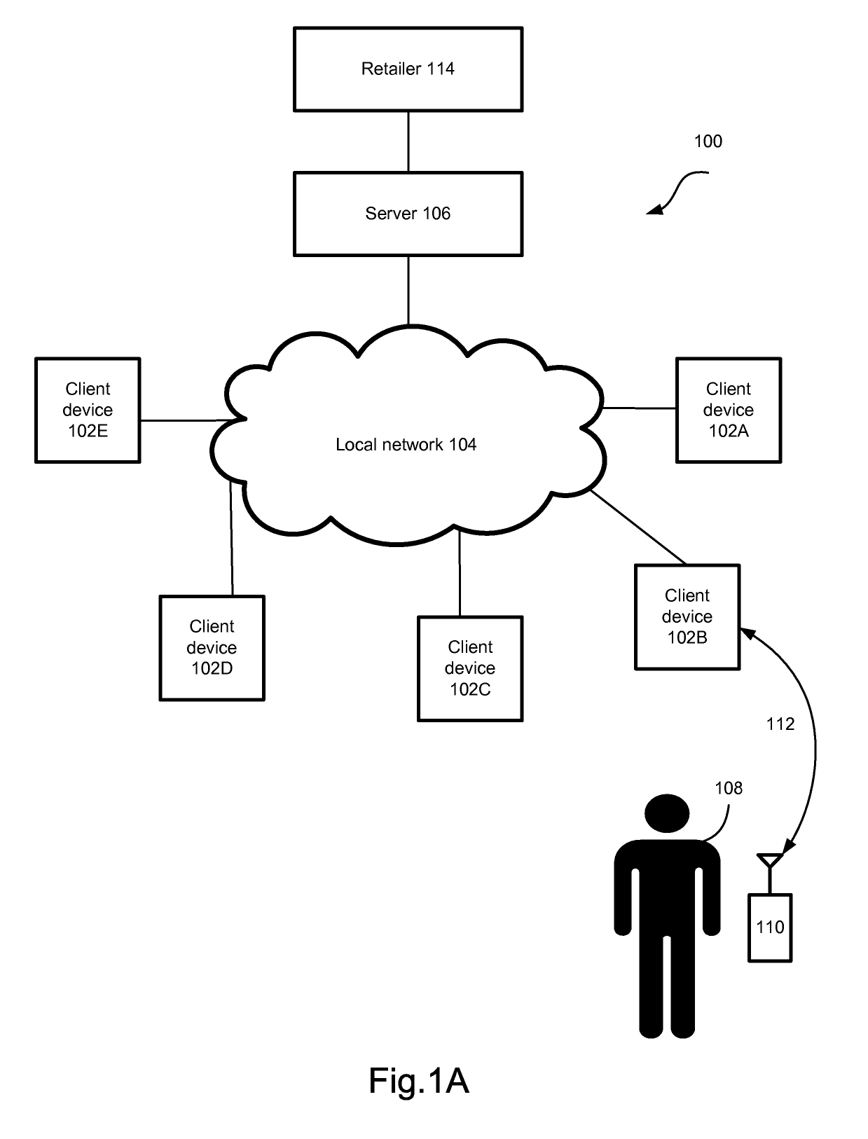

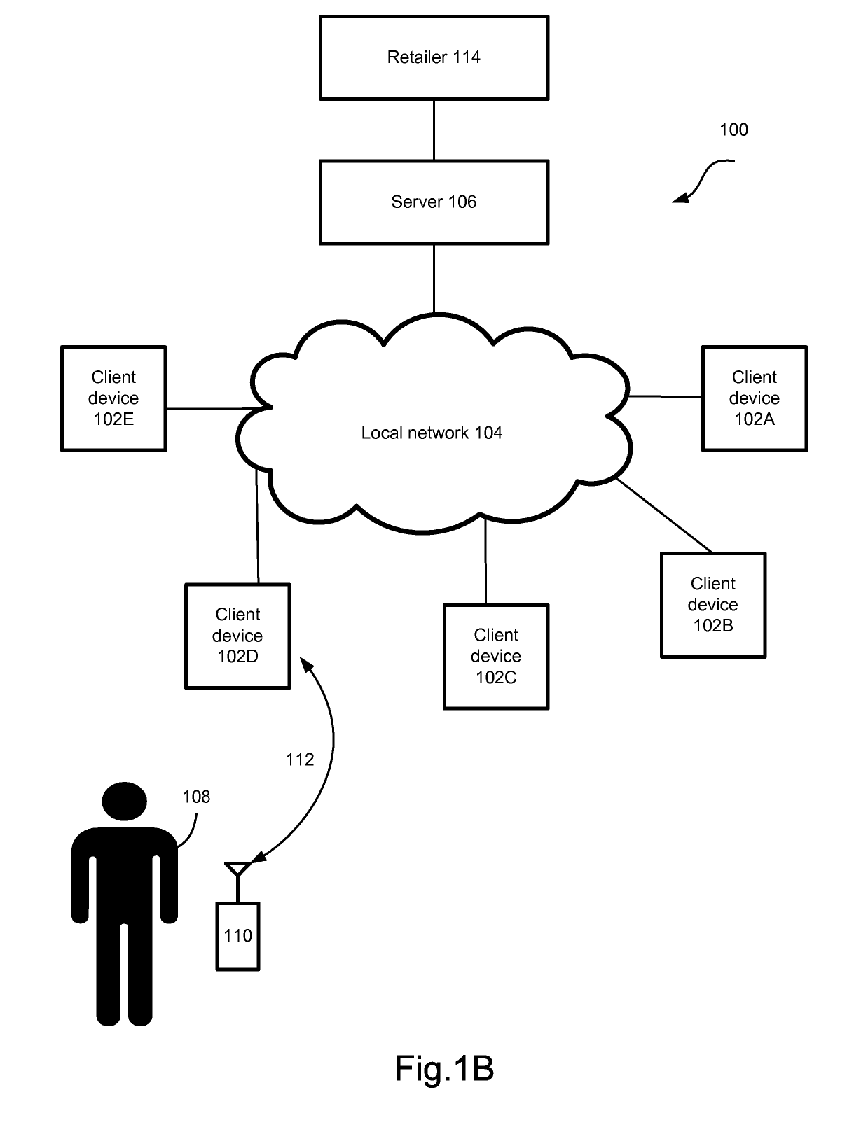

FIG. 1A is a schematic diagram illustrating an exemplary electronic system. The system 100 comprises multiple client devices 102, being illustrated exemplarily as the devices 102A to 102D, connected to a server 106 through a local communication network 104. The system 100 is placed in a shopping area including multiple displayed items. Each client device may be associated with one displayed item. The client device may include a first communication unit connecting to the server 106 through the local communication network 104. The local communication network 104 may be a WiFi (IEEE 802.11x) type of network according to one implementation. The local communication network 104 may also be a LAN using various network technologies as known in the art. The server 106 may be operated by a retailer 114. A customer 108 with a mobile communication device 110 walking around in the shopping area may be connected to any one of the clients 102 through an ad hoc communication link 112. The communication link 112 may be a Bluetooth (IEEE 802.15.1) type of connection according to one implementation. The communication link 112 may also be a ZigBee (IEEE 802.15.4), and a WiFi (IEEE 802.11x) type of communication link. The communication link 112 may even be a Near-Field-Communication (NFC) type of link conforming to ISO 18092 or ISO 21481. According to such an implementation, the mobile communication device 110 may include a RFID card and the client device 102 may include a RFID reader.

FIG. 1B is a schematic diagram illustrating that the mobile communication device 110 may be connected to a different client device 102. When the customer 108 is walking around in the shopping area, the mobile communication device 110 may maintain its connection to the local communication network 104 through a different client device time to time.

If the customer 108 is attracted by a displayed item, he may send an offering price to the associated client device 102 through the ad hoc communication network 112. The customer may also send an identity of the communication device 110 to the client device 102. The server 106 will know where the communication device 110 and therefore the customer 108 are located after the customer 108 is walked away from the client device.

After receiving an offering price, the retailer 114 may send an agreement or a counter offering price through the local network 104 to the mobile device 110 carried by the customer 108. The customer 108 and the retailer 114 may continue to negotiate as long as the customer is connected to the local network 104 through any one of the client devices 102. It should be noted that the retailer 114 may use a program stored in the server 106 or in any one of the client devices to carry out the negotiation process.

The embodiment as illustrated in FIG. 1 is exemplary. There will be variations of implementations as obvious for one with ordinary skill in the art. The client devices may possess sufficient processing power to negotiate with the customer 108 directly without using a server 106. The client devices may be connected through ad hoc communication network such as a network conforming to the ZigBee (IEEE 802.15.4) standard. According to such an implementation, some of the client devices may be used as gateways to a communication network including local and/or public communication networks.

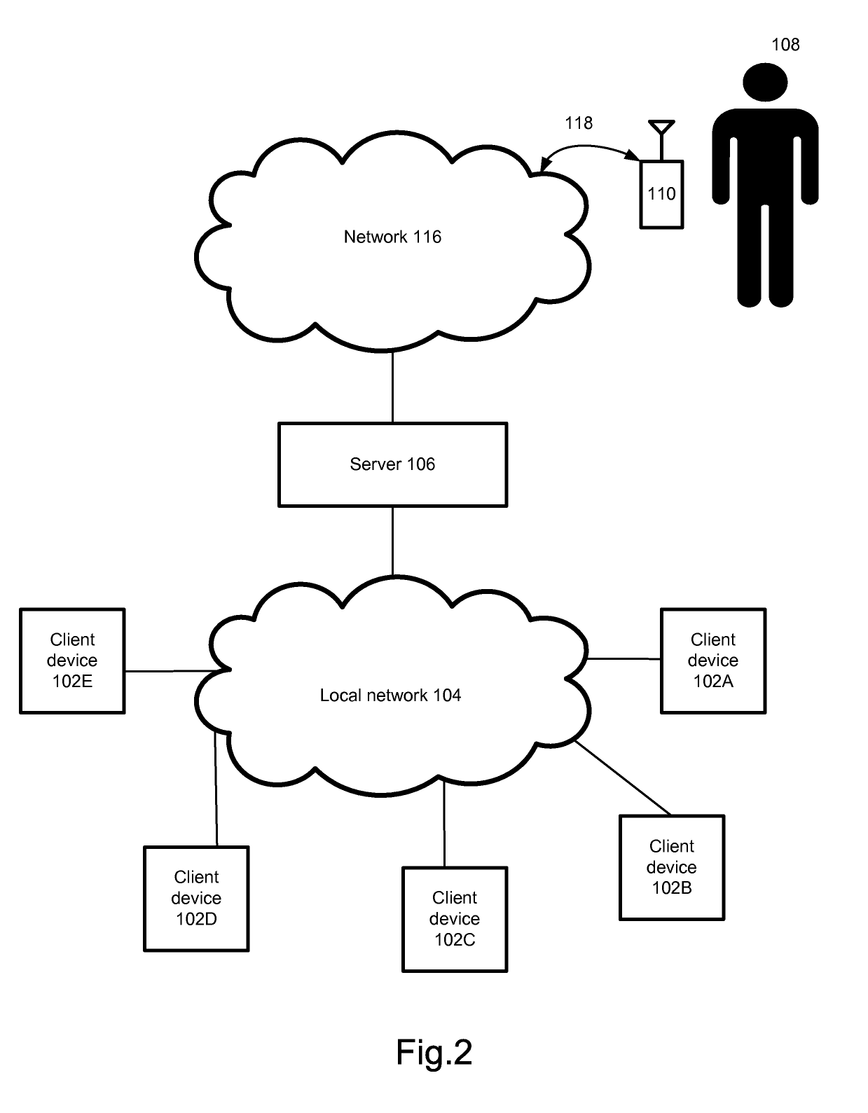

FIG. 2 is a schematic diagram illustrating that the customer 108 with the mobile communication device 110 may be connected to the sever 106 through a public communication network 116. The public communication network 116 may be a public phone network. The public communication network 116 may also be the Internet. The communication link 118 may be a wireless link as known in the art.

The customer 108 may send his communication addresses to the client device associated with a displayed item that is interested to him. The communication addresses may include a phone number, an email address and a social network address. The customer 108 may also send an offering price to the client device 102. The retailer 114 may collect addresses of a number of customers that are interested to the display item but have different price expectation than a displayed price. The retailer 114 may send promotional materials to the customers in a late stage using the communication addresses provided by the customers.

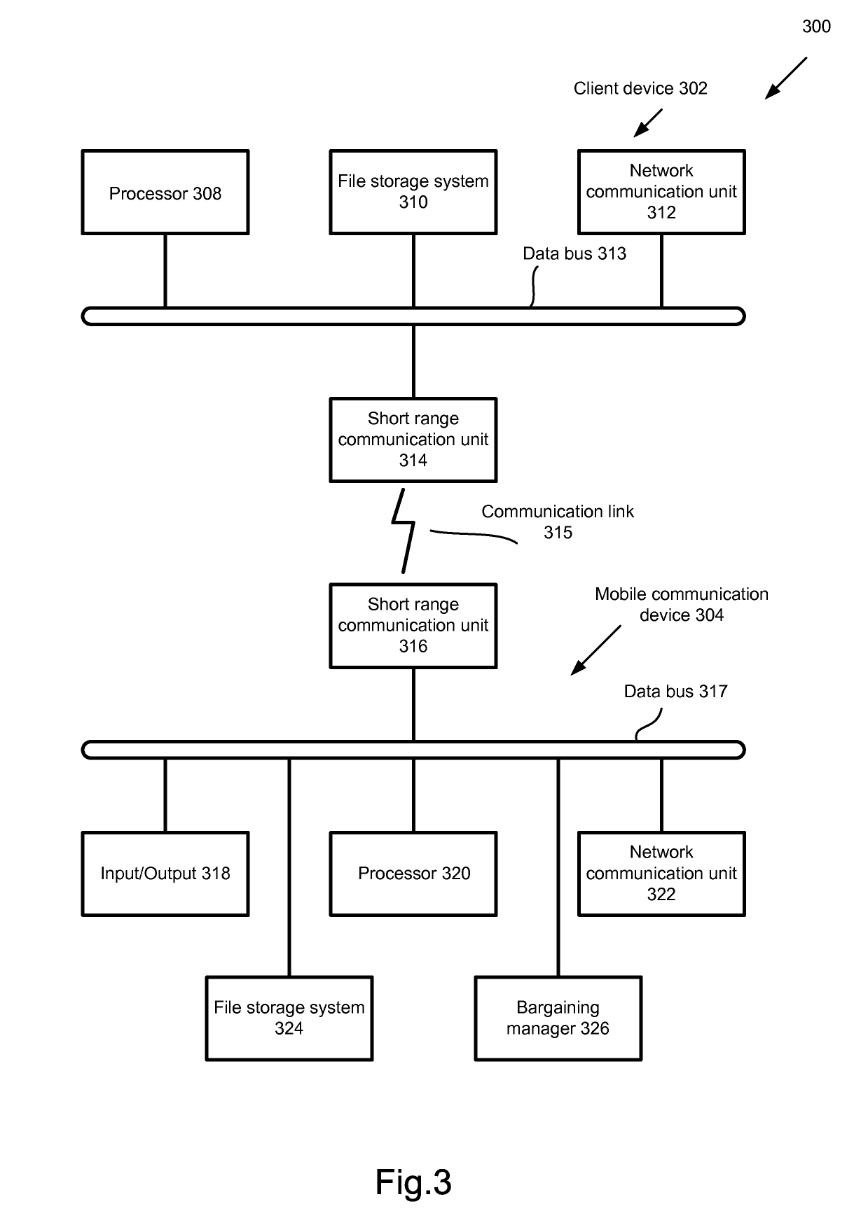

FIG. 3 is a schematic diagram illustrating functional blocks of an exemplary client device 302 and a mobile communication device 304. The client device 302 comprises a processor 308. The processor 308 may include a general purpose data processor such as a microprocessor or a microcontroller. The processor 308 may also include specific purpose data processing units. The client device 302 may further include a file storage system 310. The file storage system may include mass storage unit such as magnetic storage devices and semiconductor flash memories. The file storage system 310 may also include caches such as SRAM's for reducing access time. The client device 302 may include a network communication unit 312 for connecting the client device 302 to the local network 104. The client device 302 may also include a short range communication unit 314 for connecting the device to the mobile communication device 304 carried by the customer. The functional blocks are connected through a data bus 313.

The exemplary mobile communication device 304 comprises a short range communication unit 316. The communication units 316 and 318 conform to the same communication standard such as the Bluetooth standard (IEEE 802.15.1). The device 304 further comprises an input and output unit 318 including a display. According to one implementation, the display is a Liquid-Crystal-Display (LCD). The input and output unit 318 may further include a user interface unit for receiving the user's input. The interface unit may include keys, buttons, touch pads and touch screens. The device 304 may also comprise a processor 320. The processor 320 may include a general purpose data processor such as a microprocessor or a microcontroller. The processor 320 may also include specific purpose data processing units. A network communication unit 322 is used to connect the mobile device 304 and a communication network such as, for example, a phone network or the Internet. The device 304 may further comprise a file storage system 324. The file storage system 324 may include mass storage unit such as magnetic storage devices and semiconductor flash memories. The file storage system 324 may also include caches such as SRAM's for reducing access time. A bargaining manager 326 is used to manage the operation of the negotiation between the retailer 114 and the customer 108 using the system described in the present disclosure. The bargaining manager 326 may be implemented as a program according to one implementation.

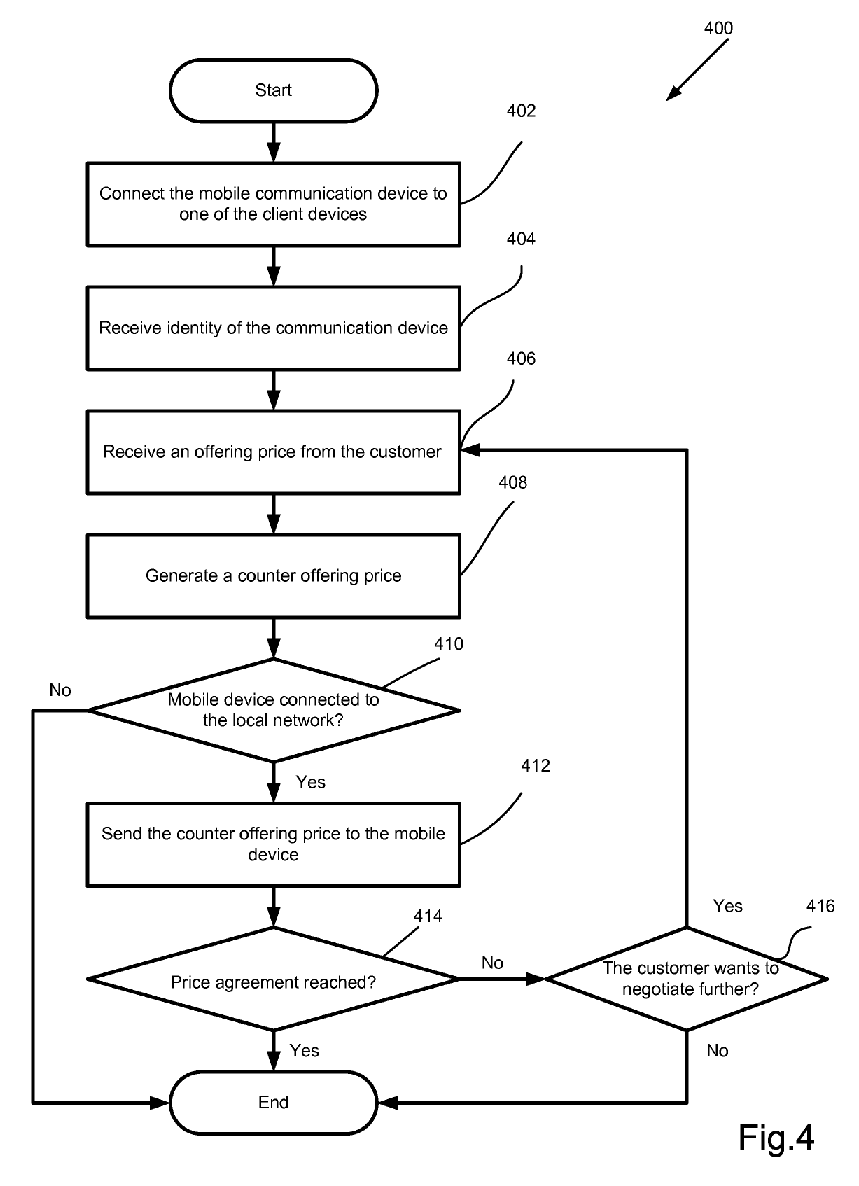

FIG. 4 is a flowchart illustrating an exemplary process that a customer 108 negotiates with a retailer 114 by using the electronic system. Process 400 starts with step 402 that the mobile communication device 110 is connected to a client device 102 associated with a displayed item through the ad hoc communication link 112. The identity of the mobile device 110 is received by the client device 102 in step 404. An offering price for the displayed item is received by the client device 102 in step 406. The received data may be sent to the server 106 and a counter offering price may be generated by the server 106 in step 408 if the retailer 114 does not agree with the offered price by the customer 108. The server 106 checks if the mobile device 108 is connected to the client device 102 associated with the displayed item or the mobile device 108 is connected through another client device in step 410. If the result is positive, a counter offering price may be sent to the customer 108 through the ad hoc communication link 112 in step 412. In step 414, the server 106 checks if a price agreement is reached between the customer 108 and the retailer 114 by receiving an acknowledgement message from the customer 108. If the result is positive, the process 400 is completed. Otherwise, the customer's willingness to continue the negotiation is judged in step 416. If the result is positive, the price negotiating steps 406 to 414 are repeated until an agreement is reached or one of the parties withdraws from the negotiation.

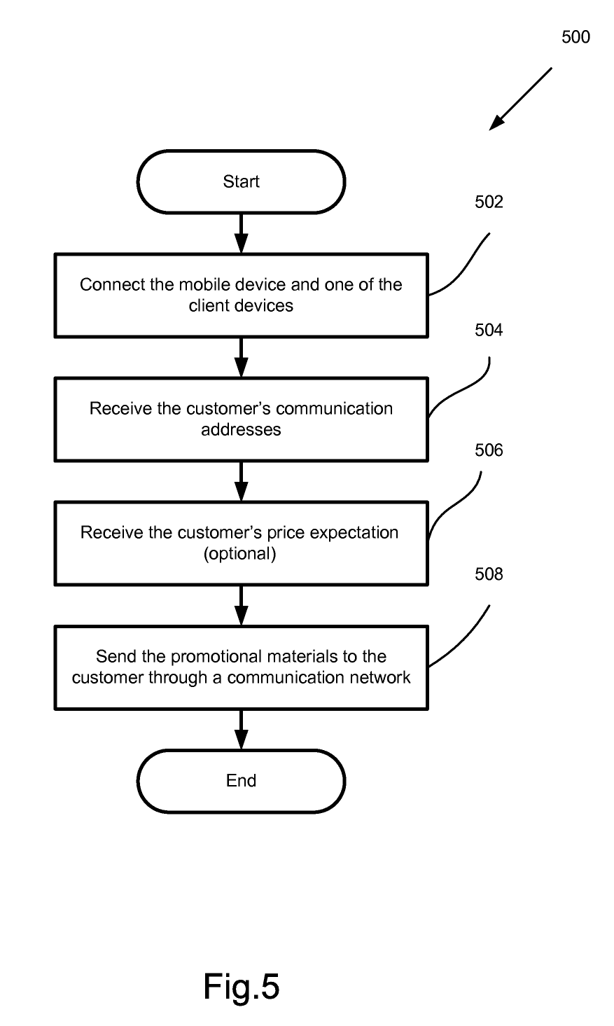

FIG. 5 is a flowchart illustrating an exemplary process that promotional materials related to a displayed item are sent to an interested customer through a public communication network. Process 500 starts with step 502 that the mobile device 110 and one of the client devices 102 is connected through an ad hoc communication link 112. The client device 102 receives the user's communication addresses in step 504. The client device 102 receives the user's price expectation for the displayed item associated with the connected client device in step 506. Promotional materials are sent to user's communication addresses in step 508. It should be noted that step 506 is optional and the retailer may send promotional materials to the customer 108 even if the system does not receive the offering price from the customer.

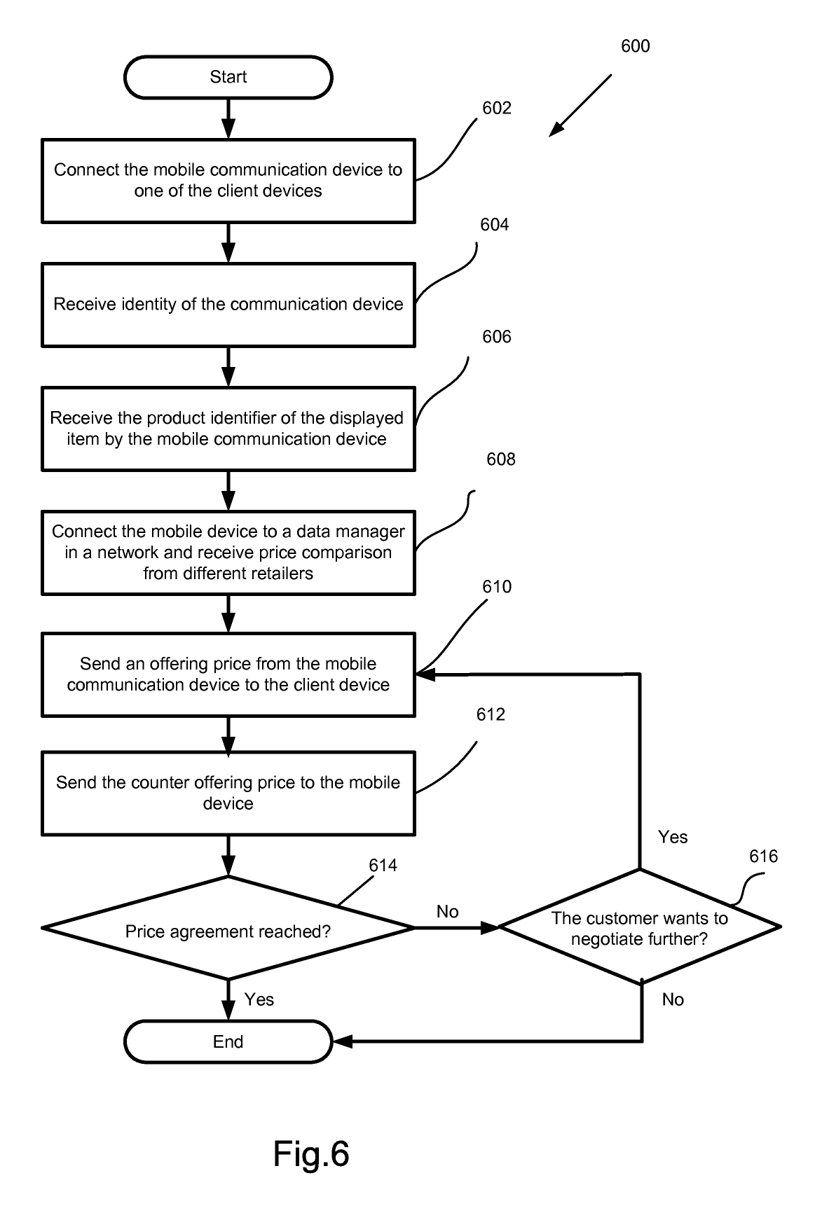

FIG. 6 is a flowchart illustrating another exemplary process that a customer 108 and a retailer 114 negotiate a purchase agreement by using the electronic system with additional information provided by a data manager connected through a public communication network. Process 600 starts with step 602 that the mobile communication device 110 is connected to one of the client devices 102 through the ad hoc communication link 112. The identity of the communication device 110 is received by the client device 102 in step 604. The displayed product identifier or any other information related the displayed item is sent from the client device 102 to the mobile communication device 110 in step 606. After receiving the product identifier or other related information, the mobile communication device 110 is connected to a data manager through a public communication network in step 608. The customer receives price comparison from different retailers by the data manager. The other product-related information such as, for example, quality, rating by customers and consumer guidelines from consumer research institutions may also be sent to the customer in step 608. The data manager may be connected to a number of retailers, a number of manufacturers and a number of customer rating organizations. After reviewing the data from the data manager, the customer 108 sends an offering price for the displayed item to the client device 102 through the ad hoc communication link 112. The retailer 114 reviews the offering price and may send back a counter offering price in step 612. The message may be accompanied with an alerting signal. If the price agreement is reached between the customer 108 and the retailer 114, the process is completed. Otherwise the willingness of the customer to continue the negotiation will be judged in step 616. If the result is positive, the steps 610 to 614 are repeated until an agreement is reached or the customer is withdrawing from the negotiation.

While the invention has been disclosed with respect to a limited number of embodiments, numerous modifications and variations will be appreciated by those skilled in the art.

It is intended that all such variations and modifications fall with in the scope of the following claims:

1. A method of bargaining between a retailer and a customer on a displayed item by using an electronic system including a plurality of client devices and a server connected through a local network, the method comprising:
a. connecting a mobile communication device carried by the customer to one of the client devices associated with at least one of the displayed items through an ad hoc communication link;
b. sending an offering price of the displayed item and a device identity of the mobile device to the client device through the ad hoc communication link;
c. receiving the offering price by said system; and
d. sending an agreement on the offered price or a counter offering price to the mobile device from any one of the client devices that is connected to the mobile communication device.

2. The method as recited in claim 1, wherein said steps (b) to (d) may be repeated until an agreement is reached or until either the retailer or the customer withdraws from the bargaining.

3. The method as recited in claim 1, wherein said method further comprising sending a data file including at least the product identifier of the displayed item from the client device to the mobile communication device.

4. The method as recited in claim 3, wherein said data file further including advertising messages about the displayed item and/or related items.

5. The method as recited in claim 1, wherein said method further comprising receiving pricing information about the displayed item from a data manager connected to a public communication network by the mobile device before the customer sending the offering price to the system.

6. The method as recited in claim 5, wherein said data manager further connecting to one or a plurality of retailers, one or a plurality of manufacturers and one or a plurality of consumer rating organizations.

7. The method as recited in claim 1, wherein said ad hoc communication link conforming to one of or a combination of the following standards:
a. Bluetooth (IEEE 802.15.1 and its extensions);
b. ZigBee (IEEE 802.15.4 and its extensions);
c. WiFi (IEEE 802.11x and its extensions); and
d. NFC (ISO 18092; or ISO 21481).

8. A method of promoting a displayed item in a shopping area from a retailer to a customer by using an electronic system including a plurality of client devices and a server connected through a local network, the method comprising:
a. connecting a mobile communication device carried by the customer to one of the client devices associated with at least one of the displayed items through an ad hoc communication link between the mobile device and the client device;
b. sending one or a plurality of communication addresses of the customer from the mobile communication device to the client device; and
c. receiving promotional materials about the displayed item or related items by the customer.

9. The method as recited in claim 8, wherein said method further comprising sending the customer's price expectation for the displayed item from the mobile communication device to the client device.

10. The method as recited in claim 8, wherein said promotional materials may be delivered from one of the connected client devices to the mobile device.

11. The method as recited in claim 8, wherein said promotion materials may be delivered through a public communication network including a public phone network and/or the Internet.

12. The method as recited in claim 8, wherein said method further comprising sending the product identifier from the client device to the mobile communication device.

13. The method as recited in claim 8, wherein said ad hoc communication link conforming to one of or a combination of the following standards:
a. Bluetooth (IEEE 802.15.1 and its extensions);
b. ZigBee (IEEE 802.15.4 and its extensions);
c. WiFi (IEEE 802.11x and its extensions); and
d. NFC (ISO 18092; or ISO 21481).

14. An electronic system in an shopping area comprising:
a. a client device at each point of a display item;
b. a local communication network connecting the client devices to a server;
c. a mobile communication device carried by a customer; and
d. an ad hoc communication link for connecting the mobile communication device and one of the client devices,
wherein the customer sends an offering price and a retailer sends an agreement or a counter offering price through the ad hoc communication link.

15. The system as recited in claim 14, wherein said system further comprising a public communication network that is used to deliver promotional materials related to the displayed item or related items after the client device receives at least one communication address of the customer from the mobile communication device.

16. The system as recited in claim 15, wherein said communication address further comprising:
a. a phone number;
b. an e-mail address; and
c. a social network address.

17. The system as recited in claim 14, wherein said client device further comprising:
a. a processor,
b. a short range ad hoc communication unit;
c. a network communication unit; and
d. a file storage system.

18. The system as recited in claim 14, wherein said communication device further comprising:
a. a processor,
b. a short range communication unit;
c. a network communication unit;
d. a file storage system;
e. a user interface; and
f. a bargaining manager.

19. The system as recited in claim 14, wherein said communication means conforming to one of or a combination of the following standards:
a. Bluetooth (IEEE 802.15.1 and its extensions);
b. ZigBee (IEEE 802.15.4 and its extensions); and
c. WiFi (IEEE 802.11x and its extensions).

20. The system as recited in claim 14, wherein said mobile communication device further comprising a RFID card and said client device further comprising a RFID reader, wherein a communication link by the card and the reader conforming to ISO 18092 or ISO 21481.
